(19) United States
(12) Patent Application Publication
(10) Pub. No.: US 2016/0016538 A1
(43) Pub. Date: Jan. 21, 2016

(54) LEAF SPRING FOR A VEHICLE WIPER BLADE

(71) Applicant: Valeo Systèmes d'Essuyage, Le Mesnil Saint Denis (FR)

(72) Inventor: Jean-François Rousseau, Charbonnier Les Mines (FR)

(73) Assignee: Valeo Systèmes d'Essuyage, Le Mesnil Saint Denis (FR)

(21) Appl. No.: 14/798,907

(22) Filed: Jul. 14, 2015

(30) Foreign Application Priority Data
Jul. 17, 2014 (FR) 1456853

(51) Int. Cl. B60S 1/34; F16F 1/26; F16F 1/18

(52) U.S. Cl. CPC B60S 1/3475; B60S 1/3495; F16F 1/18; F16F 1/26

(57) ABSTRACT

A leaf spring for a wiper blade of a vehicle window in a motor car is disclosed. The leaf spring includes at least one flexible leaf, the spring having an elongate shape and including, at a first longitudinal extremity, linking means to at least one stiffening joint of the wiper blade. The leaf spring includes or carries, at a second longitudinal extremity, a tubular member designed to receive a shaft of a driver of the wiper blade.

The present invention relates to a leaf spring for a wiper blade for a vehicle window, in particular a rear window, for example in a motor car, as well as a driver for a wiper blade, and a wiper blade including such a leaf spring and/or such a driver.

Conventionally, a wiper blade of a window of a motor vehicle includes a longitudinal body carrying a squeegee, usually made of rubber, intended to rub against the window of the vehicle to move the water out of the driver's field of vision. The blade also has at least one longitudinal joint that stiffens the squeegee to facilitate application of said squeegee to the window.

In a wiper blade for a vehicle rear window, one extremity of the arm carrying the blade is linked by a driver to the shaft of a motor that drives the blade in an angular to-and-fro movement. The driver is rigidly attached to the shaft of the motor and the arm is assembled pivotingly in relation to the driver to enable the blade to pivot, for example to enable the squeegee of same to be replaced. A spring presses the arm against the window and prevents the arm from moving away from the window by pivoting accidentally in relation to the driver. In general, this spring is a helical spring, one extremity of which is attached to the driver and the other extremity of which is attached to the arm.

Technology in which the blade is directly linked to the driver by a leaf spring has already been proposed. In this case, the leaf spring has a first extremity rigidly attached to an element of the blade and a second longitudinal extremity attached rigidly to a driver.

The invention improves on this technology, notably simplifying manufacture and assembly of the leaf spring and of the blade, and enabling on the one hand to implement the function of mechanical connection between the driver and the wiper blade, and on the other hand to allow the leaf spring to pivot in relation to the driver, which notably facilitates replacement of the blade or of the squeegee of same.

For this purpose, the invention proposes a leaf spring for a wiper blade of a vehicle window, in particular in a motor car, comprising at least one flexible leaf, the leaf spring having an elongate shape and including, at a first longitudinal extremity, at least one stiffening joint of said blade, characterized in that the leaf spring includes, at a second longitudinal extremity, a tubular member designed to receive a shaft of a driver of said blade.

The flexible nature of the leaf spring resides in the fact that it is made of a material that can easily be bent or folded without breaking, while returning to its initial position when the force that bend the leaf spring is interrupted.

This tubular member simplifies assembly of the leaf spring and of the blade on the driver. This assembly can be carried out by simply moving this tubular member in translation on the shaft of the driver. Furthermore, the tubular member can be designed to move in rotation about said shaft, at least through a given angular range. The blade is then assembled pivotingly in relation to the driver by means of the leaf spring according to the invention.

The leaf spring according to the invention may include one or more of the features below, individually or in combination:

said at least one leaf has, at a first longitudinal extremity, attachment means to said at least one stiffening joint (for example crimping means),

said at least one leaf and said at least one stiffening joint are formed from a single part,

said at least one leaf and said tubular member are formed from a single part,

said at least one leaf has a coiled longitudinal extremity defining said tubular member,

said at least one leaf has a median portion that is not flat when not stressed,

said at least one leaf has at least one orifice designed to receive a retaining pin carried on said driver, and

said tubular member has an axis of elongation substantially parallel to said at least one leaf.

The leaf spring means, a thin spring having the property of folding or bending without breaking and thus can easily return to its initial position. The leaf spring includes a tubular member for the mechanical connection between the driver and a portion of the wiper blade pressed against the wiping area. The present invention also relates to a driver for a wiper blade for a vehicle window, in particular in a motor car, comprising first attachment means to a shaft of a motor and second attachment means to a leaf spring of said blade, characterized in that said second attachment means include a shaft designed to be received in a tubular member of said leaf spring, and bearing and/or stop means designed to cooperate with said leaf spring in order to limit the rotation of said tubular member about said shaft.

The driver according to the invention may include one or more of the features below, individually or in combination:

said shaft is designed to extend substantially perpendicular to said shaft of the motor,

the driver has at least one stop designed to cooperate with said leaf spring to limit the translational movements of same along said shaft,

said bearing and/or stop means include at least one elongate leg that extends substantially parallel or perpendicular to said shaft,

said at least one leg has a first longitudinal extremity linked to a body of the driver and a second longitudinal extremity linked to a retaining pin of said leaf spring in at least one direction along said shaft, and

said pin is designed to be engaged in an orifice of said leaf spring.

The flexibility of the leaf spring allows the pivoting of the wiper blade, for instance, for the replacement of the blade.

Cooperation of the bearing and/or stop means of the driver with an intermediate portion of the leaf spring can limit the angular displacement of the wiper blade around the axis formed on the driver. The bearing and/or stop means and the axis of the driver are separated by a non-zero distance.

The present invention also relates to an assembly including a leaf spring and a driver as described above.

The present invention finally relates to a wiper blade of a vehicle window, in particular in a motor car, including a leaf spring, a driver or an assembly as described above.

The invention can be better understood from, and other details, features and advantages of the invention are set out in, the description below, given by way of non-limiting example and with reference to the attached drawings, in which:

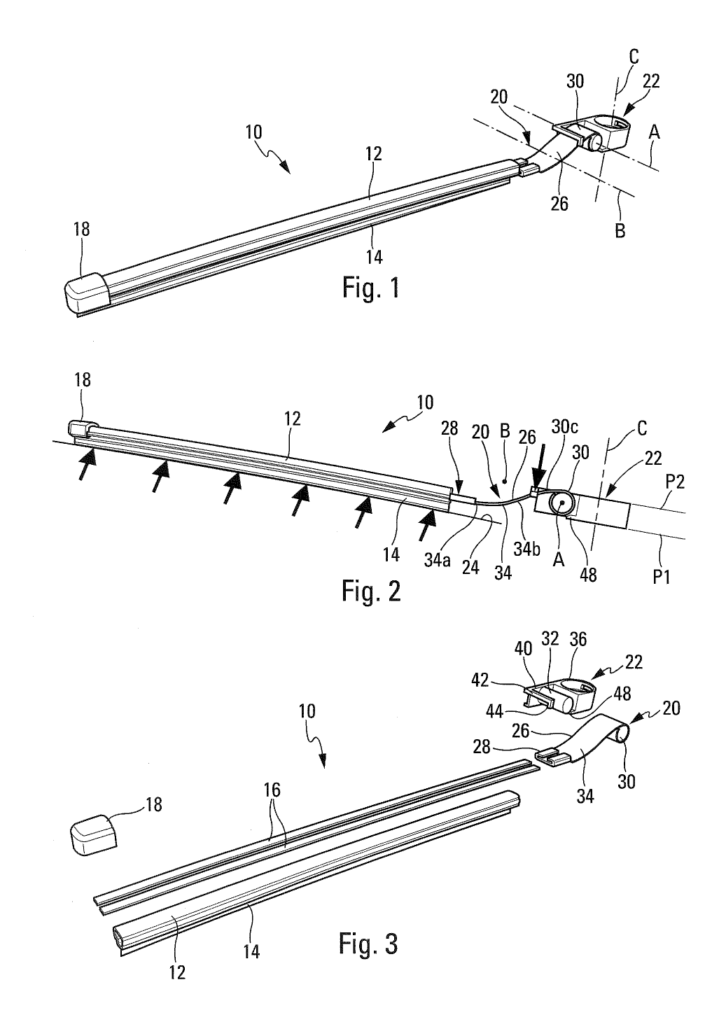

FIG. 1 is a schematic perspective view of a wiper blade according to the invention,

FIG. 2 is a schematic perspective view of the blade in FIG. 1,

FIG. 3 is a schematic perspective exploded view of the blade in FIG. 1,

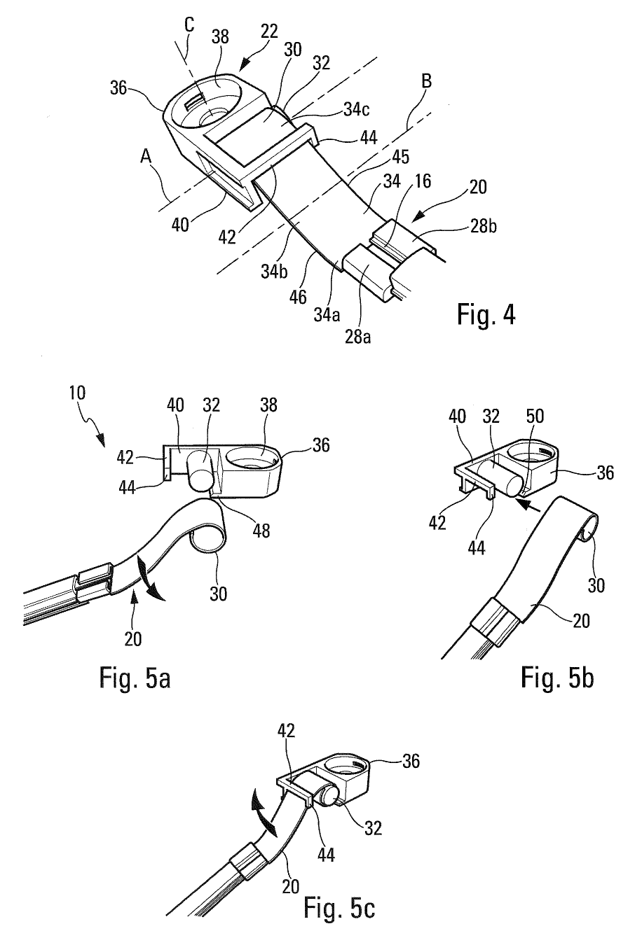

FIG. 4 is a partial schematic perspective view of one extremity of the blade in FIG. 1, on a larger scale,

FIGS. 5a to 5c are views corresponding to the view in FIG. 4 showing the assembly steps of the blade,

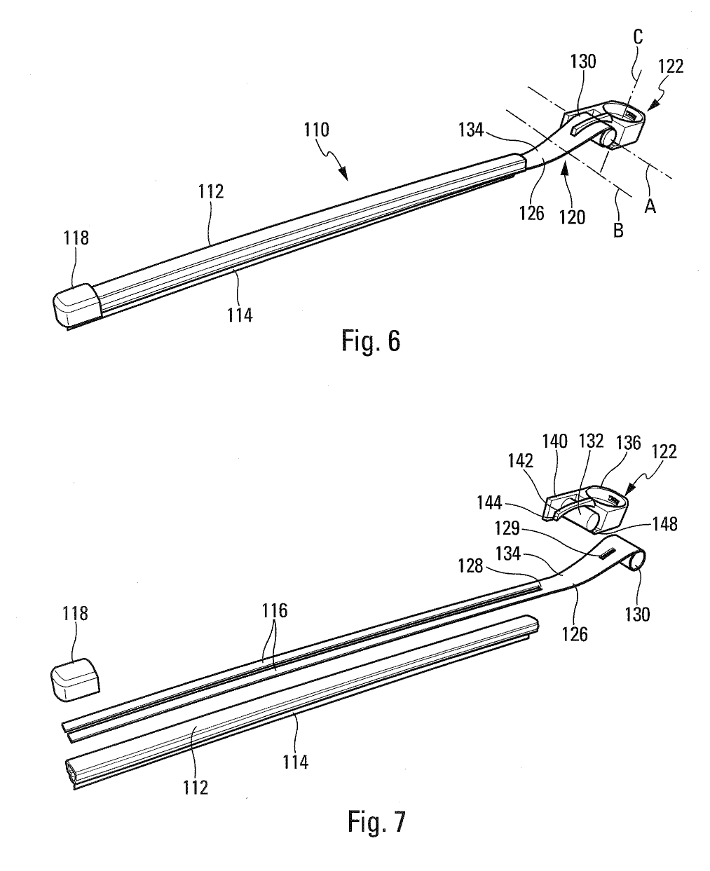

FIG. 6 is a schematic perspective view of an alternative embodiment of the wiper blade according to the invention,

FIG. 7 is a schematic perspective exploded view of the blade in FIG. 6,

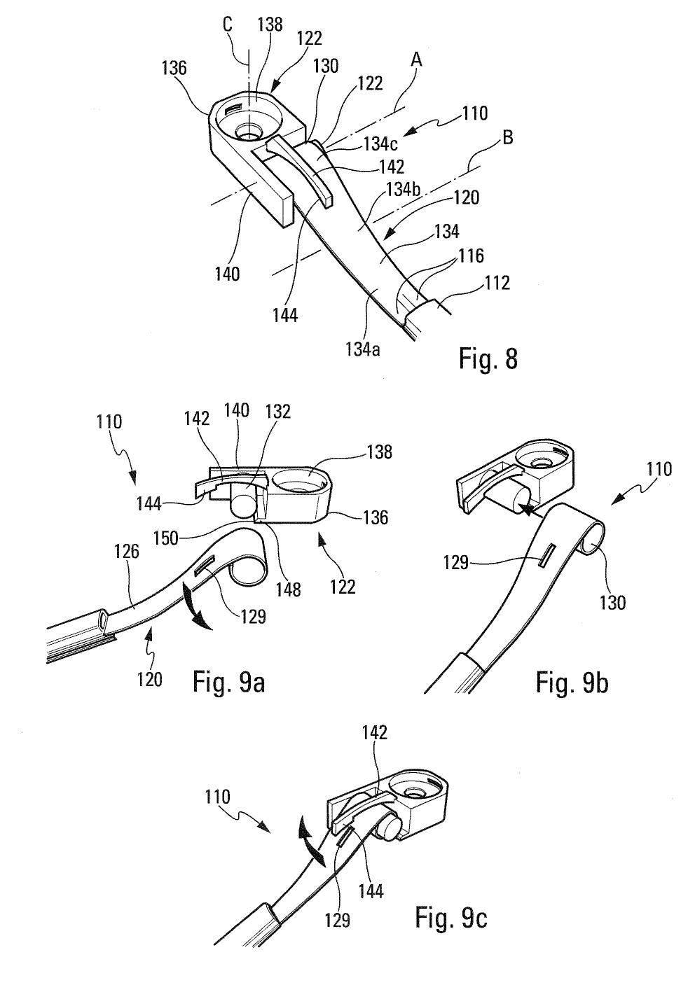

FIG. 8 is a partial schematic perspective view of one extremity of the blade in FIG. 6, on a larger scale, and

FIGS. 9a to 9c are views corresponding to the view in FIG. 8 showing the assembly steps of the blade.

It should be noted that the figures show the invention in detail to enable the invention to be carried out, and these figures may be understood to better define the invention where appropriate.

In the description below, the terms longitudinal and lateral relate to the orientation of the wiper blade according to the invention. The longitudinal direction corresponds to the main axis of the blade along which it extends, while the lateral orientations correspond to the convergent straight lines, i.e. lines crossing the longitudinal direction, notably perpendicular to the longitudinal axis of the blade in the plane of rotation of same. For the longitudinal directions, the terms external and internal are understood in relation to the axis of rotation of the blade, the term internal corresponding to the part of the blade located on the side of said axis of rotation. Finally, the directions referred to as upper and lower correspond to orientations perpendicular to the plane of rotation of the wiper, the term lower containing the plane of the window to be wiped.

FIGS. 1 to 5c, which illustrate a first embodiment of the invention, are handled first. FIGS. 1 to 3 represent a complete wiper blade 10 that is particularly but not exclusively suited to wiping a rear window of a motor car.

The wiper blade 10 essentially comprises five elements, which are most visible in FIG. 3: a longitudinal body 12 carrying a squeegee 14, at least one and in this case two stiffening joints 16, an end piece 18, a leaf spring 20 and a driver 22.

The squeegee 14 is made of rubber and is designed to rub against the window 24 (FIG. 2) of the vehicle to move the water out of the driver's field of vision. The body 12 has longitudinal lateral slots (not shown) in which are seated respectively the two joints 16. These joints 16 are parallel and coplanar and they stiffen the squeegee 14, facilitating the application of same to the window 24. The body 12 and the squeegee 14 can be made from a single part.

The end piece 18 is fitted onto the external extremities of the body 12 and of the joints 16, and is designed to hold these latter in the slots of the body 12.

The leaf spring 20 is in this case formed from a single part and comprises a single elongate leaf 26, one extremity of which includes crimping means 28 for attachment to the internal extremities of the joints 16. These attachment means 28 are for example formed by two lateral legs 28a, 28b that are folded down onto the upper face of the leaf 26 As such, the legs 28a, 28b extend above a portion of the leaf 26 and define with this portion a receiving and crimping space for the joints 16, each joint being clamped and held by one of the legs 28a, 28b.

The lower extremity of the leaf 26 is at least partially coiled about itself about an axis A substantially parallel to the leaf (or to any plane tangential to the leaf). The coiling is effected from the upper side to the lower side of the leaf 26. The internal free extremity of the leaf 26 is in this case flush with the lower surface of the squeegee. This coiling forms a tubular member 30 that is in this case made from the same part as the leaf 26 but that, in a variant, could be attached to same. This member 30 forms an internal seat for receiving a shaft 32 of the driver 22, which is described in greater detail below.

FIG. 3 shows the leaf 26 in an unstressed state. The median portion 34 of the leaf 26 extending between the attachment means 28 of same and the member 30 is not flat and includes a first external portion 34a that extends in a plane P1 passing through the attachment means 28 and parallel to the joints 16 and close to same, a second intermediate portion 34b that is curved and that extends upwards and inwards, and a third internal portion 34c that extends in a plane P2 parallel to P1 and that extends above and separated from the attachment means 28.

The leaf 26 is flexible by elastic deformation, in particular of the portions 34a, 34b, 34c of same, and more particularly of the portion 34b of same, the bending occurring about at least one axis substantially parallel to the leaf and shown by way of example using reference sign B in the drawings. This elastic deformation of the leaf 26 has the effect of generating an effort to press the wiper blade against the wiping surface.

Typically, the leaf 26 is around 2-3 mm thick and is for example made of metal.

The driver 22 includes a body 36 with an orifice 38 for assembling a shaft of a motor (not shown), in particular an electric motor, of the motor vehicle. The shaft of the motor has an axis referenced with the letter C.

The driver 22 also has a projecting lateral wall 40 on the body 36 which acts as a support for the aforementioned shaft 32. The wall 40 is substantially flat and extends in a plane substantially parallel to the axis C. It projects from an external face of the body 36 and extends from a lateral side of the body towards the rest of the blade 10. The shaft 32 extends from a lateral face of this wall 40 and is located on the external side of the body. This shaft 32 is substantially cylindrical with one extremity being connected to the wall 40 and the other extremity being free to enable the shaft 32 to be engaged in the member 30 of the spring 20. The shaft 32 therefore preferably has a diameter at least equal to and preferably slightly less than the internal diameter of the member 30.

The driver 22 also includes a transverse leg 42 carried on the wall 40. This leg 42 extends in this case from the aforementioned lateral face of the wall 40, level with the external upper corner of same. This leg 42 is elongate and extends substantially parallel to the shaft 32, it is designed to limit the rotation of the leaf spring 26 around the axis 32, while helping to maintain the member 30 on the axis 32 through a pin or hook 44. The length of same is substantially equal to the length of the shaft 32, which is substantially equal to the width of the body 36.

This leg 42 has, at the free extremity of same opposite the wall 40, a pin 44 that extends downwards and forms a retaining stop for the leaf spring 26, in a first direction parallel to the shaft 32. This pin 44 cooperates with a longitudinal edge 45 of the leaf 26, in order to maintain the positioning of the leaf 26. The wall 40 forms another retaining stop for the leaf spring in the opposite direction. The wall 40 co-operates with the other longitudinal edge 46 of the leaf. Furthermore, the leg 42 forms a supporting element on the leaf 26 to force the deformation of same and to hold the squeegee 14 pressed against the window, as shown in FIG. 2. The leg 42 bears against the upper face of the leaf 26, in this case level with the intermediate portion 34b of same, the width of which is preferably slightly less than the transverse dimension between the wall 40 and the pin 44.

The driver 22 also includes a lower guide lip 48 carried on the body 36. This lip 48 projects from the external face of the body 36 and extends from the lower side of the body towards the rest of the blade 10. It extends in a plane substantially parallel to the shaft 32, along substantially all of the transverse dimension of the body. The upper free edge 50 of same, opposite the body, is bevelled and facilitates guidance of the member 30 during assembly of same on the shaft 32 and rotation thereof about same.

The driver 22 may be formed from a single part, for example made of plastic or a composite material. It may be obtained by moulding.

Assembly of the blade 10 is described below with reference to FIGS. 5a to 5c. The leaf spring 20 is clamped onto the joints 16 once these have been assembled in the slots in the body of the blade. The end piece is assembled. The tubular member 30 of the spring is aligned with the shaft 32 of the driver 22 before or after this is assembled on the shaft of the motor (FIG. 5a) and the spring is moved such that the shaft 32 engages in the member 30 (FIGS. 5b and 5c). To achieve this, the leg 42 and the pin 44 must not hinder the translational movement of the spring parallel to the axis A.

If the driver is no longer assembled on the shaft of the engine, the spring need only be inclined in relation to the driver, by pivoting about the axis A or shaft 32, until the aforementioned insertion becomes possible, the planes tangential to the portions 34b and 34c of the leaf 26 no longer passing through the leg 42 and the pin 44. The next step involves pivoting the leaf spring 20 about the shaft 32 until it bears against the leg 42. The driver can then be attached to the shaft of the motor, this attachment resulting in a bearing force of the leg 42 on the spring and an elastic deformation of same resulting in the squeegee 14 pressing against the window 24.

If the driver 22 is already mounted on the shaft of the motor, the spring 20 needs to be deformed elastically so that the planes tangential to the portions 34b and 34c of the leaf 26 no longer pass through the leg 42 and the pin 44, enabling the aforementioned insertion. This step can be performed using an appropriate tool. The next step involves releasing the stress applied to the spring until the squeegee 14 bears against the window 24.

FIGS. 6 to 9c, which illustrate an alternative embodiment of the invention, are discussed below. FIGS. 6 and 7 represent a complete wiper blade 110 that is particularly but not exclusively suited to wiping a rear window of a motor car.

The wiper blade 110 is similar to the one described above and essentially comprises five elements, which are most visible in FIG. 7: a longitudinal body 112 carrying a squeegee 114, at least one and in this case two stiffening joints 116, an end piece 118, a leaf spring 120 and a driver 122.

The squeegee 114 is made of rubber and is designed to rub against the window of the vehicle to move the water out of the driver's field of vision. The body 112 has longitudinal lateral slots (not shown) in which are seated respectively the two joints 116. These joints 116 are parallel and coplanar and they stiffen the squeegee 114, facilitating the application of same to the window. The body 112 and the squeegee 114 can be made from a single part.

The end piece 118 is fitted onto the external extremities of the body 112 and of the joints 116, and is designed to hold these latter in the slots of the body 112.

The leaf spring 120 comprises a single elongate leaf 126, which is in this case formed from the same part as the joints 116. The external extremity of the leaf spring's blade also has some linking means 128 to link the joints 116, intrinsically into the only one-piece. It is understood from this, that the blade 126 of the leaf spring 120 and the joints 116 are unitary and one-piece made, the linking means 128 being formed by the junction portion between these joints and this blade.

The lower extremity of the leaf 126 is at least partially coiled about itself about an axis A substantially parallel to the leaf. The coiling is effected from the upper side to the lower side of the leaf 126. The internal free extremity of the leaf 126 is in this case flush with the lower surface of the squeegee. This coil forms a tubular member 130 that is in this case made from the same part as the leaf 126 but that, in a variant, could be attached to same. This member 130 forms an internal seat for receiving a shaft 132 of the driver 122, which is described in greater detail below.

FIG. 7 shows the leaf 126 in the unstressed state. The median portion 134 of the leaf 126 extending between the linking means 128 of same and the member 130 is not flat and includes a first external portion 134a that extends in a plane passing through the linking means 128 and parallel to the joints 116 and close to same, a second intermediate curved portion 134b extending upwards and inwards, and a third internal portion 134c that extends in a plane parallel to the aforementioned plane and that extends above and separated from the linking means 128.

The intermediate portion 134b of the leaf 126 has an orifice 129 that is designed to receive a pin 144 of the driver 122, as described in greater detail below.

The leaf 126 is flexible by elastic deformation, in particular of the portions 134a, 134b, 134c of same, and more particularly of the portion 134b of same, the bending occurring about at least one axis substantially parallel to the leaf and shown by way of example using reference sign B in the drawings.

Typically, the leaf 126 is around 2-3 mm thick and is for example made of metal.

The driver 122 includes a body 136 with an orifice 138 for assembling a shaft of a motor (not shown), in particular an electric motor, of the motor vehicle. The shaft of the motor has an axis referenced with the letter C.

The driver 122 also has a projecting lateral wall 140 on the body which acts as a support for the aforementioned shaft 132. The wall 140 is substantially flat and extends in a plane substantially parallel to the axis C. It projects from an external face of the body 136 and extends from a lateral side of the body 136 towards the rest of the blade 110. The shaft 132 extends from a lateral face of this wall 140 and is located on the external side of the body. This shaft 132 is substantially cylindrical with one extremity being connected to the wall 140 and the other extremity being free to enable the shaft 132 to be engaged with the member 130 of the spring 120. The shaft 132 therefore preferably has a diameter at least equal to and preferably slightly less than the internal diameter of the member 130.

The driver 122 also has a longitudinal leg 142 carried on the body 136. This leg 142 extends in this case from the aforementioned external face of the body, level with the upper edge of same. This leg 142 is elongate and extends substantially perpendicular to the axes A and C. In this case, the length of same is slightly greater than the length of the wall 40.

This leg 142 has, at the free extremity of same opposite the body 136, a pin 144 that extends downwards and forms retaining stops for the leaf spring 126, in both directions parallel to the shaft 132. The pin 144 is engaged in the orifice 129 of the leaf 126 and cooperates with the longitudinal edges of this orifice 129. Furthermore, the leg 142 bears against the leaf 126 to force the deformation of same and to hold the squeegee 114 pressed against the window, as shown in FIG. 12. The leg 142 bears against the upper face of the leaf 126, in this case level with the intermediate portion 134b of same, the width of which is preferably slightly less than the transverse dimension between the wall 140 and the pin 144.

The driver 122 also includes a lower guide lip 148 carried on the body 136. This lip 148 projects from the external face of the body 136 and extends from a lower side of the body towards the rest of the blade 110. It extends in a plane substantially parallel to the shaft 132, along substantially all of the transverse dimension of the body. The other free edge 50 of same, opposite the body, is bevelled and facilitates guidance of the member 130 during assembly of same on the shaft 132 and rotation thereof about same.

The driver 122 may be formed from a single part, for example made of plastic or a composite material. It may be obtained by moulding.

The blade 110 may be assembled in the same way as the blade 10, FIGS. 9a to 9c showing the related assembly steps.

1. A leaf spring for a wiper blade of a vehicle window in a motor car, comprising:
at least one flexible leaf, the leaf spring having an elongate shape and including, at a first longitudinal extremity, at least one stiffening joint of said blade,
wherein the leaf spring includes, at a second longitudinal extremity, a tubular member designed to receive a shaft of a driver of said blade.

2. The leaf spring according to claim 1, wherein said at least one leaf has, at a first longitudinal extremity, attachment means to said at least one stiffening joint.

3. The leaf spring according to claim 1, wherein in that said at least one leaf and said at least one stiffening joint are formed from a single part.

4. The leaf spring according to claim 1, wherein said at least one leaf and said tubular member are formed from a single part.

5. The leaf spring according to claim 1, wherein said at least one leaf has a coiled longitudinal extremity defining said tubular member.

6. The leaf spring according to claim 1, wherein in that said at least one leaf has a median portion that is not flat when not stressed.

7. The leaf spring according to claim 1, wherein said at least one leaf has at least one orifice designed to receive a retaining pin carried on said driver.

8. The leaf spring according to claim 1, wherein in that said tubular member has an axis of elongation substantially parallel to said at least one leaf.

9. A driver for a wiper blade for a vehicle window in a motor car, comprising:
first attachment means to a shaft of a motor; and
second attachment means to a leaf spring of said blade,
wherein said second attachment means include a shaft designed to be received in a tubular member of said leaf spring, and bearing and/or stop means designed to cooperate with said leaf spring in order to limit the rotation of said tubular member about said shaft.

10. The driver according to claim 9, further comprising a projecting lateral wall on a body which acts as a support for the aforementioned shaft.

11. The driver according to claim 9, wherein said shaft is designed to extend substantially perpendicular to said shaft of the motor.

12. The driver according to claim 9, further comprising, at least one stop designed to cooperate with said leaf spring to limit the translational movements of same along said shaft.

13. The driver according to claim 9, wherein said bearing and/or stop means include at least one elongate leg that extends substantially parallel or perpendicular to said shaft.

14. The driver according to claim 13, wherein said at least one leg has a first longitudinal extremity linked to a body of the driver and a second longitudinal extremity linked to a retaining pin of said leaf spring in at least one direction along said shaft.

15. The driver according to claim 14, wherein said pin is designed to be engaged in an orifice of said leaf spring.

16. A wiper blade of a vehicle window in a motor car, comprising:
a leaf spring according to claim 1; and
a driver comprising:
first attachment means to a shaft of a motor; and
second attachment means to a leaf spring of said blade,
wherein said second attachment means include a shaft configured to be received in a tubular member of said leaf spring, and bearing and/or stop means designed to cooperate with said leaf spring in order to limit the rotation of said tubular member about said shaft.
